(19) United States
(12) Patent Application Publication
(10) Pub. No.: US 2019/0108571 A1
(43) Pub. Date: Apr. 11, 2019

(54) SYSTEM AND METHOD FOR EFFICIENTLY DETERMINING RELEVANT PRODUCTS FOR DISPLAY IN AN ONLINE MARKETPLACE

(71) Applicant: Cognizant Technology Solutions India Pvt. Ltd., Chennai (IN)

(72) Inventors: Abhishek Kar, Kolkata (IN); Kaushal Tak, Jhunjhunu (IN)

(21) Appl. No.: 15/822,685

(22) Filed: Nov. 27, 2017

(30) Foreign Application Priority Data
Oct. 5, 2017 (IN) 201741035332

(51) Int. Cl. G06Q 30/06; G06Q 30/02; G06Q 10/08; G06F 17/16; G06F 17/18; G06F 17/30; G06K 9/62

(52) U.S. Cl. CPC G06Q 30/0631; G06Q 30/0202; G06Q 30/0643; G06Q 30/0255; G06K 9/6267; G06Q 10/087; G06F 17/16; G06F 17/18; G06F 17/30707; G06Q 30/06

(57) ABSTRACT

A system, computer-implemented method and computer program product for determining relevant products for display in an online marketplace is provided. The system comprises a stock categorization module to identify products from an inventory database and categorize each of the identified products. The system further comprises a matrix generator to receive a transaction history of the customers and generate a matrix comprising products purchased by the customers from each of the one or more categories. Furthermore, the system comprises a probability calculator configured to convert the generated matrix into a probability matrix and a clustering module to fetch attributes of each of the one or more products and cluster the customers. In addition, the system comprises a customer questions database to receive one or more preferences from the one or more customers for an instant shopping session and a category list generator to display relevant product assortment corresponding to each customer.

### FIELD OF THE INVENTION

The present invention relates generally to electronic commerce. More particularly, the present invention provides a system and method for efficiently determining relevant products for display in an online marketplace.

### BACKGROUND OF THE INVENTION

Electronic commerce (e-commerce) industry has grown significantly in the past few years, as a result many online marketplaces have emerged. For any e-commerce company, online merchandising and product assortment play a vital role in success of its online marketplace.

Conventionally, various systems and methods exist for determining products for display in an online marketplace. Most e-commerce companies use demographic filtering for displaying relevant products to customers. The e-commerce companies analyze demographic data related to customers and form clusters of customers based on the analyzed data. The customers are then displayed products based on the clusters to which they belong. However, the abovementioned systems and methods suffer from various disadvantages. For instance, customers who buy products from top price range are displayed the same products as the ones who buy from the cheapest price range. Even if the customers choose the filter option to sort products based on price, there is no guarantee that displayed products will meet other requirements such as purpose of purchase and general affinity towards certain attributes. As a result, a lot of customers tend to navigate away from the online marketplace after viewing only the first page thereby increasing the bounce rate.

In light of the abovementioned disadvantages, there is a need for a system and method for efficiently determining relevant products for display in an online marketplace. Further, there is a need for a system and method that facilitates personalization of assortment of products displayed to the customers. Furthermore, there is a need for a system and method that reduces bounce rate thereby benefitting the e-commerce companies.

### SUMMARY OF THE INVENTION

A system, computer-implemented method and computer program product for determining relevant products for display in an online marketplace is provided. The system comprises a stock categorization module configured to identify one or more products from an inventory database, categorize each of the one or more identified products based on one or more pre-defined product types and categorize the one or more identified products corresponding to each pre-defined product type into one or more categories based on one or more attributes. The system further comprises a matrix generator configured to receive a transaction history of the one or more customers and generate a matrix comprising products purchased by one or more customers from each of the one or more categories. Furthermore, the system comprises a probability calculator configured to convert the generated matrix into a probability matrix, wherein the probability matrix represents probability of the one or more customer buying products from each of the one or more categories. The system also comprises a clustering module configured to fetch, from the inventory database, attributes of each of the one or more products within the one or more categories and cluster the one or more customers using the fetched attributes of each of the one or more products purchased by the one or more customers and the probability matrix. In addition, the system comprises a customer questions database configured to receive one or more preferences from the one or more customers for an instant shopping session. The system further comprises a category list generator configured to display relevant product assortment corresponding to each of the one or more customers based on the cluster to which the one or more customers belong and the one or more received preferences.

In an embodiment of the present invention, the inventory database is part of an existing enterprise system and comprises information related to browsing history of the one or more customers, products viewed by the one or more customers, products purchased by the one or more customers, transaction history of the one or more customers, products available for sale, sold out products and category and attributes of all the products. In an embodiment of the present invention, the one or more pre-defined product types comprise books, clothing, jewelry and appliances. In an embodiment of the present invention, the one or more preferences from the one or more customers for the instant shopping session are received by providing a set of questions to the one or more customers. In an embodiment of the present invention, the one or more customers are clustered based on similarity of the fetched attributes of each of the one or more products purchased by the one or more customers.

The computer-implemented method for determining relevant products for display in an online marketplace, via program instructions stored in a memory and executed by a processor, comprises identifying one or more products from an inventory database. The computer-implemented method further comprises categorizing each of the one or more identified products based on one or more pre-defined product types. Furthermore, the computer-implemented method comprises categorizing the one or more identified products corresponding to each pre-defined product type into one or more categories based on one or more attributes. In addition, the computer-implemented method comprises receiving a transaction history of the one or more customers. Also, the computer-implemented method comprises generating a matrix comprising products purchased by one or more customers from each of the one or more categories. The computer-implemented method comprises converting the generated matrix into a probability matrix, wherein the probability matrix represents probability of the one or more customer buying products from each of the one or more categories. Furthermore, the computer-implemented method comprises fetching, from the inventory database, attributes of each of the one or more products within the one or more categories. The computer-implemented method also comprises clustering the one or more customers using the fetched attributes of each of the one or more products purchased by the one or more customers and the probability matrix. The computer-implemented method further comprises receiving one or more preferences from the one or more customers for an instant shopping session. Furthermore, the computer-implemented method comprises displaying relevant product assortment corresponding to each of the one or more customers based on the cluster to which the one or more customers belong and the one or more received preferences.

The computer program product for determining relevant products for display in an online marketplace comprises a non-transitory computer-readable medium having computer-readable program code stored thereon, the computer-readable program code comprising instructions that when executed by a processor, cause the processor to identify one or more products from an inventory database. The processor further categorizes each of the one or more identified products based on one or more pre-defined product types. Furthermore, the processor categorizes the one or more identified products corresponding to each pre-defined product type into one or more categories based on one or more attributes. The processor also receives a transaction history of the one or more customers. The processor then generates a matrix comprising products purchased by one or more customers from each of the one or more categories. The processor further converts the generated matrix into a probability matrix, wherein the probability matrix represents probability of the one or more customer buying products from each of the one or more categories. Furthermore, the processor fetches, from the inventory database, attributes of each of the one or more products within the one or more categories. The processor also clusters the one or more customers using the fetched attributes of each of the one or more products purchased by the one or more customers and the probability matrix. The processor then receives one or more preferences from the one or more customers for an instant shopping session. The processor also displays relevant product assortment corresponding to each of the one or more customers based on the cluster to which the one or more customers belong and the one or more received preferences.

### BRIEF DESCRIPTION OF THE ACCOMPANYING DRAWINGS

The present invention is described by way of embodiments illustrated in the accompanying drawings wherein:

FIG. 1 is a block diagram illustrating a system for efficiently determining relevant products for display in an online marketplace, in accordance with an embodiment of the present invention;

FIGS. 2A and 2B represent a flowchart illustrating a method for efficiently determining relevant products for display in an online marketplace, in accordance with an embodiment of the present invention; and

FIG. 3 illustrates an exemplary computer system for efficiently determining relevant products for display in an online marketplace, in accordance with an embodiment of the present invention.

### DETAILED DESCRIPTION OF THE INVENTION

A system and method for efficiently determining relevant products for display in an online marketplace is described herein. The invention provides for a system and method that facilitates personalization of assortment of products displayed to one or more customers. The invention further provides a system and method that reduces bounce rate thereby benefitting the e-commerce companies.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

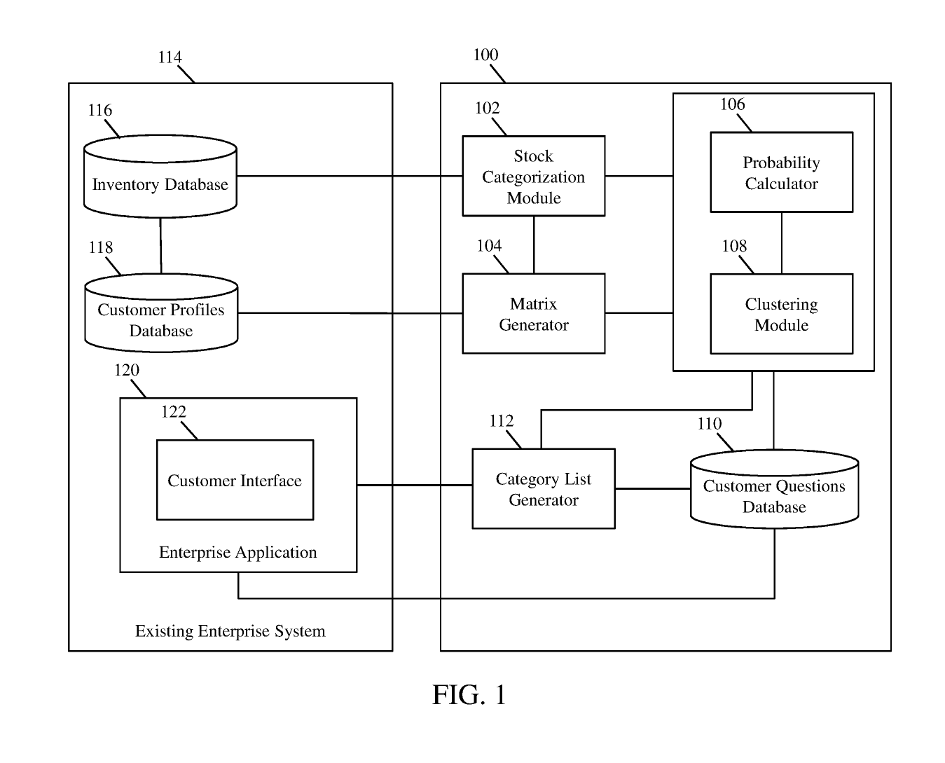

FIG. 1 is a block diagram illustrating a system 100 for efficiently determining relevant products for display in an online marketplace, in accordance with an embodiment of the present invention. The system 100 comprises a stock categorization module 102, a matrix generator 104, a probability calculator 106, a clustering module 108, a customer questions database 110 and a category list generator 112. Further, the system 100 communicates with an existing enterprise system 114.

The stock categorization module 102 is configured to identify one or more products from an inventory database 116. The inventory database 116 is part of the existing enterprise system 114. The inventory database 116 comprise information related to browsing history of one or more customers, products viewed by the one or more customers, products purchased by the one or more customers, products available for sale, sold out products and category and attributes of all the products. The stock categorization module 102 is also configured to categorize each of the one or more identified products based on one or more pre-defined product types. The one or more pre-defined product types include, but not limited to, books, clothing, jewelry and appliances. The stock categorization module 102 is further configured to categorize the one or more identified products corresponding to each pre-defined product type into one or more categories based on one or more attributes. For example, books are further categorized based on their genre and author.

The matrix generator 104 is configured to receive customers' transaction history from a customer profiles database 116 residing within the existing enterprise system 114. In operation, once a product is purchased by a customer, the inventory database 116 is configured to update the customer profiles database 118. Particularly, the customer's profile is updated by the inventory database 116 to reflect the purchase of product. In an embodiment of the present invention, a unique Identification (ID) of the product is updated in the customer profiles database 118 after a customer purchases corresponding product.

Once the transaction history corresponding to the customer is received, the matrix generator 104 is configured to generate a matrix comprising one or more products purchased by the customer from each of the one or more categories.

The probability calculator 106 is configured to convert the matrix into a probability matrix, wherein the probability matrix represents probability of the customer buying the one or more products from each of the one or more categories. In an embodiment of the present invention, the probability matrix that contains the probability of buying the one or more products from each of the one or more categories is mostly sparse and therefore the probability calculator 106 uses Laplace smoothing. Further, Laplace Smoothing ensures that products which have not been bought or viewed by the customer are assigned probabilities using Laplace smoothing. The probability calculator 106 then calculates collinearity coefficients. The collinearity coefficients with respect to the most preferable category by products are added to the rest of the categories for each customer. The probability matrix is then normalized to get a number proportional to the probability of the customer buying from each category.

The clustering module 108 is configured to fetch, from the inventory database 116, one or more attributes of each of the one or more products purchased by the one or more customers. The clustering module 108 is further configured to create one or more clusters of the one or more customers using the fetched attributes of each of the one or more products purchased by the one or more customers and the probability matrix corresponding to each customer, wherein each cluster is formed based on similarity of attributes. Each of one or more clusters comprise a group of similar attributes. For example, in case of books, each author represents a class or level. Further, similar authors are grouped together to form a cluster.

During operation, the clustering module 108 considers each product in each of the one or more categories. Each product is defined by the one or more attributes. The one or more attributes are then clustered. For instance, in case of authors if there are 102 authors and A_1, A_2, A_3, A_4, A_5 are similar as these are generally liked by customers in a cluster of customers, then these 5 authors are clustered as one group and labelled as Author_Bucket_1. The probability is then calculated for the customer choosing a particular cluster from the labelled clusters formed for product attributes assuming the attributes are independent. The clustering module 108 performs weighted clustering again giving higher weightage to price. Further, weighted clustering is performed by scaling the parameters according to customer preference. The clustering module 108 then computes probability for choosing a single row from the generated matrix using Multinomial Logit Model assuming the distribution to be Gumble.

The customer questions database 110 is configured to receive one or more preferences from the one or more customers during a session. In an embodiment of the present invention, the one or more preferences are received by providing a set of questions to the customer via a customer interface 122 on an enterprise application 120. In an embodiment of the present invention, the customer is prompted to answer questions such as, but not limited to, ‘What is the average price of the similar products he owns’, ‘What color of shirt would he like to be gifted by anyone?’ and the likes. Further, customer's answers to the set of questions that represent his preferences are received by the customer questions database 110. The customer questions database 110 facilitates in identifying the cluster with attributes that match the customer's preferences. The number of products chosen from the identified cluster are increased in the first set of product assortment to generate a final set of product assortment which is displayed to the customer via the customer interface 122.

In an embodiment of the present invention, to increase efficiency, all permissible assortments possible for a set of questions are generated by the category list generator 112 prior to receiving the one or more preferences from the one or more customers. On receiving the one or more preferences, the category list generator 112 displays the most relevant product assortment corresponding to the received one or more preferences.

In an embodiment of the present invention, the system 100 provides multiple product assortments that are relevant to a particular customer and displays one assortment from the multiple product assortments based on the customer's preferences/answers to the questions. Further, the questions presented to the customer are product specific and the final product assortment displayed is specific to the customer's preferences during a particular browsing session.

In an exemplary embodiment of the present invention, let us consider an example of a customer purchasing books. The products are divided into different categories based on product type which in case of books may be genres. Similarly, categories in case of clothing and fashion products may be based on brands. The categories are defined in a manner to efficiently distinguish one category of products from other. The past transaction history of the customer is received and products that the customer has bought from different categories are identified.

Table 1 below represent number of purchases in different genres of books by four customers (C_1 to C_4).

| | Sci-Fi | Romance | Thriller | Biographies |
|---|---|---|---|---|
| C_1 | 10 | 0 | 2 | 12 |
| C_2 | 1 | 7 | 9 | 0 |
| C_3 | 0 | 8 | 6 | 1 |
| C_4 | 9 | 1 | 0 | 10 |

In an embodiment of the present invention, the categories are mutually exclusive. Further, probability of a customer buying from each category is calculated, as illustrated in table 2 below, using the past transaction history of the customers.

| | Sci-Fi | Romance | Thriller | Biographies |
|---|---|---|---|---|
| C_1 | 0.404 | 0.019 | 0.096 | 0.481 |
| C_2 | 0.0789 | 0.394 | 0.5 | 0.027 |
| C_3 | 0.029 | 0.5 | 0.383 | 0.088 |
| C_4 | 0.432 | 0.068 | 0.023 | 0.477 |

In an embodiment of the present invention, a variant of Laplace smoothing is then applied on the probability matrix and the collinearity coefficients are computed. The collinearity coefficients with respect to the most preferable and second most preferable category by products are averaged and added to the rest of the categories for each customer. The collinearity coefficients are calculated using the formula below:

$${ρ}_{X , Y} = \frac{E [ XY ] - E [ X ] E [ Y ]}{\sqrt{E [ {X}^{2} ] - {[ E [ X ] ]}^{2}} \sqrt{E [ {Y}^{2} ] - {[ E [ Y ] ]}^{2}}} .$$

where X and Y represent rows between which the correlation coefficient is being calculated.

The probability matrix is then normalized to get a number proportional to the probability of customer buying from each category. After normalization, each individual product within a category is considered. The products within a category are defined by their attributes. For example, in case of books, the books within a genre (example sci-fi) are segregated based on attributes such as, but not limited to, name of the author, number of pages in a book, last print date, price and discount. Each class variable (i.e. category) is then converted to corresponding dummy variables (example author denoted by A_i wherein A_i represents i^{th} author). The matrix then shows number of products bought for each dummy variable (A_1 to A_4 represent authors for sci-fi category) by the customer. The customers are then clustered using a clustering algorithm by the clustering module 108. In an embodiment of the present invention, the clustering module 108 employs k-means clustering based on the attributes with maximum number of levels/class.

Once the one or more clusters of customers are obtained, for each cluster, similar authors are considered as one group to obtain one or more clusters of attributes.

The obtained clusters are then converted to new variables in the matrix and the components that formed it are removed. The variables from the preceding step are then considered independently and their weight for customer buying from each cluster is computed. Weighted clustering is again performed by giving higher weightage to price. This is done by scaling the parameters or attributes (price in the present example) according to the customer preference related to the parameters. Further, probability is computed for selecting a single row from the above matrix using a Multinomial Logit Model while assuming the distribution to be Gumble.

The Gumbel has the following cumulative distribution and probability density functions:

F(∈)=exp{−exp[−μ(∈−η)]}

f(∈)=μ×{exp[−μ(∈−η)]}×exp{−exp[−μ(∈−η)]}

where μ is the scale parameter which determines the variance of the distribution and η is the location (mode) parameter.

In an embodiment of the present invention, the system 100 provides options to facilitate the ecommerce company to display special products and configure number of products to be displayed in each probability range thereby displaying slightly pricey products to a customer that otherwise buys cheaper products to facilitate increase in revenue.

Once the probability of buying each product is computed, the products with highest preference are then used to generate a first set of assortment based on any additional constraints provided by the website developer such as, but not limited to, the number of products to be displayed on a single page.

The customer is then provided a set of questions to receive customer preferences and a final product assortment is determined based on the received preferences during a particular browsing session.

In an exemplary embodiment of the present invention, table 1 below illustrates a matrix comprising number of products purchased by the one or more customer from each of the one or more categories. The customers are shown in the rows and the number of times purchase made from different categories such as genres in case of books is represented in each column. In the instant example, only 12 genres are considered. However, there can be numerous categories and genres.

TABLE 1

| | G1 | G2 | G3 | G4 | G5 | G6 | G7 | G8 | G9 | G10 | G11 | G12 |
|---|---|---|---|---|---|---|---|---|---|---|---|---|
| C_1 | 1 | 0 | 1 | 1 | 3 | 0 | 0 | 0 | 1 | 0 | 0 | 1 |
| C_2 | 5 | 0 | 0 | 1 | 3 | 0 | 0 | 0 | 0 | 1 | 0 | 0 |
| C_3 | 0 | 4 | 0 | 0 | 2 | 2 | 1 | 0 | 1 | 0 | 0 | 0 |
| C_4 | 1 | 1 | 0 | 0 | 0 | 5 | 3 | 2 | 0 | 0 | 0 | 0 |
| C_5 | 0 | 0 | 3 | 5 | 0 | 0 | 0 | 0 | 0 | 0 | 0 | 0 |
| C_6 | 1 | 5 | 1 | 0 | 1 | 1 | 6 | 2 | 0 | 0 | 3 | 0 |
| C_7 | 0 | 1 | 0 | 0 | 0 | 0 | 1 | 0 | 0 | 2 | 0 | 2 |
| C_8 | 0 | 5 | 0 | 0 | 0 | 0 | 0 | 0 | 0 | 0 | 0 | 0 |
| C_9 | 0 | 0 | 0 | 0 | 0 | 0 | 0 | 2 | 0 | 0 | 0 | 0 |
| C_10 | 4 | 0 | 0 | 0 | 5 | 0 | 0 | 0 | 0 | 0 | 0 | 0 |
| C_11 | 0 | 7 | 0 | 0 | 0 | 1 | 1 | 0 | 0 | 0 | 0 | 0 |
| C_12 | 0 | 0 | 0 | 0 | 0 | 0 | 5 | 0 | 5 | 5 | 0 | 3 |
| C_13 | 3 | 0 | 0 | 0 | 0 | 0 | 0 | 0 | 0 | 1 | 0 | 0 |
| C_14 | 0 | 0 | 0 | 0 | 5 | 0 | 0 | 0 | 0 | 0 | 0 | 3 |
| C_15 | 2 | 10 | 0 | 3 | 0 | 0 | 0 | 0 | 0 | 1 | 5 | 0 |

In an exemplary embodiment of the present invention, the probability matrix for the above example considering the 12 genres is illustrated in Table 2 below.

TABLE 2

| | G1 | G2 | G3 | G4 | G5 | G6 | G7 | G8 | G9 | G10 | G11 | G12 |
|---|---|---|---|---|---|---|---|---|---|---|---|---|
| C_1 | 0.125 | 0 | 0.125 | 0.125 | 0.375 | 0 | 0 | 0 | 0.125 | 0 | 0 | 0.125 |
| C_2 | 0.5 | 0 | 0 | 0.1 | 0.3 | 0 | 0 | 0 | 0 | 0.1 | 0 | 0 |
| C_3 | 0 | 0.4 | 0 | 0 | 0.2 | 0.2 | 0.1 | 0 | 0.1 | 0 | 0 | 0 |
| C_4 | 0.083333 | 0.083333 | 0 | 0 | 0 | 0.416667 | 0.25 | 0.166667 | 0 | 0 | 0 | 0 |
| C_5 | 0 | 0 | 0.375 | 0.625 | 0 | 0 | 0 | 0 | 0 | 0 | 0 | 0 |
| C_6 | 0.05 | 0.25 | 0.05 | 0 | 0.05 | 0.05 | 0.3 | 0.1 | 0 | 0 | 0.15 | 0 |
| C_7 | 0 | 0.166667 | 0 | 0 | 0 | 0 | 0.166667 | 0 | 0 | 0.333333 | 0 | 0.333333 |
| C_8 | 0 | 1 | 0 | 0 | 0 | 0 | 0 | 0 | 0 | 0 | 0 | 0 |
| C_9 | 0 | 0 | 0 | 0 | 0 | 0 | 0 | 1 | 0 | 0 | 0 | 0 |
| C_10 | 0.444444 | 0 | 0 | 0 | 0.555556 | 0 | 0 | 0 | 0 | 0 | 0 | 0 |
| C_11 | 0 | 0.777778 | 0 | 0 | 0 | 0.111111 | 0.111111 | 0 | 0 | 0 | 0 | 0 |
| C_12 | 0 | 0 | 0 | 0 | 0 | 0 | 0.277778 | 0 | 0.277778 | 0.277778 | 0 | 0.166667 |
| C_13 | 0.75 | 0 | 0 | 0 | 0 | 0 | 0 | 0 | 0 | 0.25 | 0 | 0 |
| C_14 | 0 | 0 | 0 | 0 | 0.625 | 0 | 0 | 0 | 0 | 0 | 0 | 0.375 |
| C_15 | 0.095238 | 0.47619 | 0 | 0.142857 | 0 | 0 | 0 | 0 | 0 | 0.047619 | 0.238095 | 0 |

On applying Laplace smoothing to the matrix in Table 2, the probability calculator 106 generates the following matrix illustrated in Table 3 below.

TABLE 3

| | G1 | G2 | G3 | G4 | G5 | G6 | G7 | G8 |
|---|---|---|---|---|---|---|---|---|
| C_1 | 0.086538 | 0.076923 | 0.086538 | 0.086538 | 0.105769 | 0.076923 | 0.076923 | 0.076923 |
| C_2 | 0.115385 | 0.076923 | 0.076923 | 0.084615 | 0.1 | 0.076923 | 0.076923 | 0.076923 |
| C_3 | 0.076923 | 0.107692 | 0.076923 | 0.076923 | 0.092308 | 0.092308 | 0.084615 | 0.076923 |
| C_4 | 0.083333 | 0.083333 | 0.076923 | 0.076923 | 0.076923 | 0.108974 | 0.096154 | 0.089744 |
| C_5 | 0.076923 | 0.076923 | 0.105769 | 0.125 | 0.076923 | 0.076923 | 0.076923 | 0.076923 |
| C_6 | 0.080769 | 0.096154 | 0.080769 | 0.076923 | 0.080769 | 0.080769 | 0.1 | 0.084615 |
| C_7 | 0.076923 | 0.089744 | 0.076923 | 0.076923 | 0.076923 | 0.076923 | 0.089744 | 0.076923 |
| C_8 | 0.076923 | 0.153846 | 0.076923 | 0.076923 | 0.076923 | 0.076923 | 0.076923 | 0.076923 |
| C_9 | 0.076923 | 0.076923 | 0.076923 | 0.076923 | 0.076923 | 0.076923 | 0.076923 | 0.153846 |
| C_10 | 0.111111 | 0.076923 | 0.076923 | 0.076923 | 0.119658 | 0.076923 | 0.076923 | 0.076923 |
| C_11 | 0.076923 | 0.136752 | 0.076923 | 0.076923 | 0.076923 | 0.08547 | 0.08547 | 0.076923 |
| C_12 | 0.076923 | 0.076923 | 0.076923 | 0.076923 | 0.076923 | 0.076923 | 0.098291 | 0.076923 |
| C_13 | 0.134615 | 0.076923 | 0.076923 | 0.076923 | 0.076923 | 0.076923 | 0.076923 | 0.076923 |
| C_14 | 0.076923 | 0.076923 | 0.076923 | 0.076923 | 0.125 | 0.076923 | 0.076923 | 0.076923 |
| C_15 | 0.084249 | 0.113553 | 0.076923 | 0.087912 | 0.076923 | 0.076923 | 0.076923 | 0.076923 |

| | G9 | G10 | G11 | G12 |
|---|---|---|---|---|
| C_1 | 0.086538 | 0.076923 | 0.076923 | 0.086538 |
| C_2 | 0.076923 | 0.084615 | 0.076923 | 0.076923 |
| C_3 | 0.084615 | 0.076923 | 0.076923 | 0.076923 |
| C_4 | 0.076923 | 0.076923 | 0.076923 | 0.076923 |
| C_5 | 0.076923 | 0.076923 | 0.076923 | 0.076923 |
| C_6 | 0.076923 | 0.076923 | 0.088462 | 0.076923 |
| C_7 | 0.076923 | 0.102564 | 0.076923 | 0.102564 |
| C_8 | 0.076923 | 0.076923 | 0.076923 | 0.076923 |
| C_9 | 0.076923 | 0.076923 | 0.076923 | 0.076923 |
| C_10 | 0.076923 | 0.076923 | 0.076923 | 0.076923 |
| C_11 | 0.076923 | 0.076923 | 0.076923 | 0.076923 |
| C_12 | 0.098291 | 0.098291 | 0.076923 | 0.089744 |
| C_13 | 0.076923 | 0.096154 | 0.076923 | 0.076923 |
| C_14 | 0.076923 | 0.076923 | 0.076923 | 0.105769 |
| C_15 | 0.076923 | 0.080586 | 0.095238 | 0.076923 |

After applying Laplace smoothing, the probability calculator 106 determines collinearity coefficients. The collinearity coefficients with respect to the most preferable category by products are added to the rest of the categories for each customer and the matrix in Table 3 is then normalized to generate matrix illustrated in Table 4 below.

TABLE 4

| | G1 | G2 | G3 | G4 | G5 | G6 | G7 | G8 |
|---|---|---|---|---|---|---|---|---|
| C_1 | 0.103089 | 0.056808 | 0.078515 | 0.075845 | 0.166053 | 0.070187 | 0.054839 | 0.067754 |
| C_2 | 0.168484 | 0.057866 | 0.071834 | 0.077962 | 0.105195 | 0.071289 | 0.058347 | 0.071229 |
| C_3 | 0.059221 | 0.171802 | 0.068868 | 0.072008 | 0.059976 | 0.096922 | 0.087858 | 0.071689 |
| C_4 | 0.068338 | 0.089459 | 0.069423 | 0.066865 | 0.067474 | 0.159876 | 0.11947 | 0.084199 |
| C_5 | 0.072109 | 0.065593 | 0.152054 | 0.157783 | 0.070702 | 0.065492 | 0.057215 | 0.069368 |
| C_6 | 0.052382 | 0.07749 | 0.063829 | 0.054811 | 0.04974 | 0.111007 | 0.149376 | 0.071955 |
| C_7 | 0.098074 | 0.060871 | 0.06204 | 0.064894 | 0.056059 | 0.05854 | 0.099249 | 0.063864 |
| C_8 | 0.059221 | 0.175564 | 0.068868 | 0.072008 | 0.058722 | 0.095668 | 0.087231 | 0.071689 |
| C_9 | 0.071608 | 0.070421 | 0.07699 | 0.074805 | 0.068798 | 0.087907 | 0.080382 | 0.17246 |
| C_10 | 0.105026 | 0.056808 | 0.077757 | 0.075087 | 0.167148 | 0.070187 | 0.054839 | 0.067754 |
| C_11 | 0.059221 | 0.174171 | 0.068868 | 0.072008 | 0.058722 | 0.096365 | 0.087927 | 0.071689 |
| C_12 | 0.052109 | 0.076122 | 0.063555 | 0.054811 | 0.049467 | 0.110733 | 0.149254 | 0.071408 |
| C_13 | 0.170016 | 0.057866 | 0.071834 | 0.077349 | 0.103357 | 0.071289 | 0.058347 | 0.071229 |
| C_14 | 0.10233 | 0.056808 | 0.077757 | 0.075087 | 0.167569 | 0.070187 | 0.054839 | 0.067754 |
| C_15 | 0.059818 | 0.17228 | 0.068868 | 0.072904 | 0.058722 | 0.095668 | 0.087231 | 0.071689 |

| | G9 | G10 | G11 | G12 |
|---|---|---|---|---|
| C_1 | 0.08447 | 0.060712 | 0.067798 | 0.113931 |
| C_2 | 0.069298 | 0.107892 | 0.077871 | 0.062732 |
| C_3 | 0.073106 | 0.067098 | 0.105766 | 0.065687 |
| C_4 | 0.07802 | 0.060948 | 0.073249 | 0.062679 |
| C_5 | 0.07262 | 0.066175 | 0.083822 | 0.067066 |
| C_6 | 0.10313 | 0.096045 | 0.086158 | 0.084078 |
| C_7 | 0.102785 | 0.153094 | 0.069163 | 0.111367 |
| C_8 | 0.072479 | 0.067098 | 0.105766 | 0.065687 |
| C_9 | 0.07421 | 0.070229 | 0.080621 | 0.071568 |
| C_10 | 0.083712 | 0.060712 | 0.067798 | 0.113172 |
| C_11 | 0.072479 | 0.067098 | 0.105766 | 0.065687 |
| C_12 | 0.10465 | 0.097565 | 0.085337 | 0.08499 |
| C_13 | 0.069298 | 0.108811 | 0.077871 | 0.062732 |
| C_14 | 0.083712 | 0.060712 | 0.067798 | 0.115447 |
| C_15 | 0.072479 | 0.067397 | 0.107259 | 0.065687 |

The control is now transferred to the clustering module 108. In the instant example, for ease of understanding let us consider two genres from the 12 shown in Table 4. Further, for these two genres, 5 authors from 1 genre and 4 authors from the 2 genre are considered, wherein the authors are attributes. In an embodiment of the present invention, the same method is applicable for any number of genres and authors. The last three columns in Table 5 below illustrate the number of products that fall in different price ranges. Three price ranges (i.e. Lower end (P1), Middle price (P2) and higher price (P3)) are being considered in this example. Other features/attributes associated with books are not considered in this example for ease of understanding. The invention can also be applied if other features/attributes are included.

TABLE 5

| | A1_G1 | A2_G1 | A3_G1 | A4_G1 | A5_G1 | A1_G2 | A2_G2 | A3_G2 | A4_G2 | P1 | P2 | P3 |
|---|---|---|---|---|---|---|---|---|---|---|---|---|
| C_1 | | | | 1 | | | | | | 1 | | |
| C_2 | | | 2 | 2 | | | | | | | 3 | 1 |
| C_3 | | | | | | 2 | | 1 | 1 | 2 | 2 | |
| C_4 | | | | 1 | | 1 | | | | 1 | 1 | |
| C_5 | | | | | | | | | | | | |
| C_6 | | 1 | | | | 2 | | 3 | | 1 | 4 | 1 |
| C_7 | | 1 | | | | | | | | | | 1 |
| C_8 | | | | | | 4 | | 1 | | 2 | 3 | |
| C_9 | | | | | | | | | | | | |
| C_10 | | | 2 | 2 | | | | | | 4 | | |
| C_11 | 3 | 2 | | | 2 | | | | | 1 | 5 | |
| C_12 | | | | | | | | | | | | |
| C_13 | 1 | | | | 2 | | | | | | 3 | |
| C_14 | | | | | | | | | | | | |
| C_15 | | | 1 | 1 | | 2 | 1 | 5 | 2 | 2 | 9 | 1 |

In an embodiment of the present invention, customers are clustered based on the authors. Further, 6 clusters are formed as illustrated in Table 6 below. Furthermore, NULL values are replaced with 0.

TABLE 6

| | A1_G1 | A2_G1 | A3_G1 | A4_G1 | A5_G1 | A1_G2 | A2_G2 | A3_G2 | A4_G2 | P1 | P2 | P3 | Cluster |
|---|---|---|---|---|---|---|---|---|---|---|---|---|---|
| C_1 | 0 | 0 | 0 | 1 | 0 | 0 | 0 | 0 | 0 | 1 | 0 | 0 | 2 |
| C_2 | 0 | 0 | 2 | 2 | 0 | 0 | 0 | 0 | 0 | 0 | 3 | 1 | 4 |
| C_3 | 0 | 0 | 0 | 0 | 0 | 2 | 0 | 1 | 1 | 2 | 2 | 0 | 5 |
| C_4 | 0 | 0 | 0 | 1 | 0 | 1 | 0 | 0 | 0 | 1 | 1 | 0 | 2 |
| C_5 | 0 | 0 | 0 | 0 | 0 | 0 | 0 | 0 | 0 | 0 | 0 | 0 | 2 |
| C_6 | 0 | 1 | 0 | 0 | 0 | 2 | 0 | 3 | 0 | 1 | 4 | 1 | 3 |
| C_7 | 0 | 1 | 0 | 0 | 0 | 0 | 0 | 0 | 0 | 0 | 0 | 1 | 2 |
| C_8 | 0 | 0 | 0 | 0 | 0 | 4 | 0 | 1 | 0 | 2 | 3 | 0 | 5 |
| C_9 | 0 | 0 | 0 | 0 | 0 | 0 | 0 | 0 | 0 | 0 | 0 | 0 | 2 |
| C_10 | 0 | 0 | 2 | 2 | 0 | 0 | 0 | 0 | 0 | 4 | 0 | 0 | 4 |
| C_11 | 3 | 2 | 0 | 0 | 2 | 0 | 0 | 0 | 0 | 1 | 5 | 0 | 1 |
| C_12 | 0 | 0 | 0 | 0 | 0 | 0 | 0 | 0 | 0 | 0 | 0 | 0 | 2 |
| C_13 | 1 | 0 | 0 | 0 | 2 | 0 | 0 | 0 | 0 | 0 | 3 | 0 | 1 |
| C_14 | 0 | 0 | 0 | 0 | 0 | 0 | 0 | 0 | 0 | 0 | 0 | 0 | 2 |
| C_15 | 0 | 0 | 1 | 1 | 0 | 2 | 1 | 5 | 2 | 2 | 9 | 1 | 6 |

In an embodiment of the present invention, let us consider one particular cluster, for example Cluster 2 illustrated in Table 7 below.

TABLE 7

| | A1_G1 | A2_G1 | A3_G1 | A4_G1 | A5_G1 | A1_G2 | A2_G2 | A3_G2 | A4_G2 | P1 | P2 | P3 | Cluster |
|---|---|---|---|---|---|---|---|---|---|---|---|---|---|
| C_1 | 0 | 0 | 0 | 1 | 0 | 0 | 0 | 0 | 0 | 1 | 0 | 0 | 2 |
| C_4 | 0 | 0 | 0 | 1 | 0 | 1 | 0 | 0 | 0 | 1 | 1 | 0 | 2 |
| C_5 | 0 | 0 | 0 | 0 | 0 | 0 | 0 | 0 | 0 | 0 | 0 | 0 | 2 |
| C_7 | 0 | 1 | 0 | 0 | 0 | 0 | 0 | 0 | 0 | 0 | 0 | 1 | 2 |
| C_9 | 0 | 0 | 0 | 0 | 0 | 0 | 0 | 0 | 0 | 0 | 0 | 0 | 2 |
| C_12 | 0 | 0 | 0 | 0 | 0 | 0 | 0 | 0 | 0 | 0 | 0 | 0 | 2 |
| C_14 | 0 | 0 | 0 | 0 | 0 | 0 | 0 | 0 | 0 | 0 | 0 | 0 | 2 |

In an embodiment of the present invention, the most diverse classes or feature are authors in the matrix generated in the case of books. The matrix containing only customers and authors is then considered as illustrated in Table 8 below.

TABLE 8

| | A1_G1 | A2_G1 | A3_G1 | A4_G1 | A5_G1 | A1_G2 | A2_G2 | A3_G2 | A4_G2 |
|---|---|---|---|---|---|---|---|---|---|
| C_1 | 0 | 0 | 0 | 1 | 0 | 0 | 0 | 0 | 0 |
| C_4 | 0 | 0 | 0 | 1 | 0 | 1 | 0 | 0 | 0 |
| C_5 | 0 | 0 | 0 | 0 | 0 | 0 | 0 | 0 | 0 |
| C_7 | 0 | 1 | 0 | 0 | 0 | 0 | 0 | 0 | 0 |
| C_9 | 0 | 0 | 0 | 0 | 0 | 0 | 0 | 0 | 0 |
| C_12 | 0 | 0 | 0 | 0 | 0 | 0 | 0 | 0 | 0 |
| C_14 | 0 | 0 | 0 | 0 | 0 | 0 | 0 | 0 | 0 |

For reducing dimensionality, the clustering module 108 has multiple options. In the instant example, k-means clustering is used. A transpose of the matrix is generated as illustrated in Table 9 below.

TABLE 9

| | C_1 | C_4 | C_5 | C_7 | C_9 | C_12 | C_14 |
|---|---|---|---|---|---|---|---|
| A1_G1 | 0 | 0 | 0 | 0 | 0 | 0 | 0 |
| A2_G1 | 0 | 0 | 0 | 1 | 0 | 0 | 0 |
| A3_G1 | 0 | 0 | 0 | 0 | 0 | 0 | 0 |
| A4_G1 | 1 | 1 | 0 | 0 | 0 | 0 | 0 |
| A5_G1 | 0 | 0 | 0 | 0 | 0 | 0 | 0 |
| A1_G2 | 0 | 1 | 0 | 0 | 0 | 0 | 0 |
| A2_G2 | 0 | 0 | 0 | 0 | 0 | 0 | 0 |
| A3_G2 | 0 | 0 | 0 | 0 | 0 | 0 | 0 |
| A4_G2 | 0 | 0 | 0 | 0 | 0 | 0 | 0 |

The authors are then clustered as illustrated in Table 10 below.

TABLE 10

| | C_1 | C_4 | C_5 | C_7 | C_9 | C_12 | C_14 | Cluster |
|---|---|---|---|---|---|---|---|---|
| A1_G1 | 0 | 0 | 0 | 0 | 0 | 0 | 0 | 2 |
| A2_G1 | 0 | 0 | 0 | 1 | 0 | 0 | 0 | 1 |
| A3_G1 | 0 | 0 | 0 | 0 | 0 | 0 | 0 | 2 |
| A4_G1 | 1 | 1 | 0 | 0 | 0 | 0 | 0 | 3 |
| A5_G1 | 0 | 0 | 0 | 0 | 0 | 0 | 0 | 2 |
| A1_G2 | 0 | 1 | 0 | 0 | 0 | 0 | 0 | 3 |
| A2_G2 | 0 | 0 | 0 | 0 | 0 | 0 | 0 | 2 |
| A3_G2 | 0 | 0 | 0 | 0 | 0 | 0 | 0 | 2 |
| A4_G2 | 0 | 0 | 0 | 0 | 0 | 0 | 0 | 2 |

The authors are then converted into one cluster as illustrated in Table 11 below.

TABLE 11

| | C_1 | C_4 | C_5 | C_7 | C_9 | C_12 | C_14 |
|---|---|---|---|---|---|---|---|
| Cluster_1 | 1 | 1 | 0 | 0 | 0 | 0 | 0 |
| Cluster_2 | 0 | 1 | 0 | 0 | 0 | 0 | 0 |
| Cluster_3 | 0 | 0 | 0 | 1 | 0 | 0 | 0 |

Another matrix (illustrated in Table 12 below) providing the mapping between the authors and the cluster they belong to is also generated.

TABLE 12

| | | | | | | |
|---|---|---|---|---|---|---|
| Cluster_1 | A2_G1 | | | | | |
| Cluster_2 | A1_G1 | A3_G1 | A5_G1 | A2_G2 | A3_G2 | A4_G2 |
| Cluster_3 | A4_G1 | A1_G2 | | | | |

In an embodiment of the present invention, the matrix containing the cluster number and the customers is transposed. Further, probability of customer buying from each cluster is computed using the frequentist approach similar to one used above and then Laplace smoothing is applied. The prices columns and other variable columns present in the beginning of the clustering are then added. The matrix illustrated in Table 13 is then generated.

TABLE 13

| | Cluster_1 | Cluster_2 | Cluster_3 | P1 | P2 | P3 |
|---|---|---|---|---|---|---|
| C_1 | 0.5 | 0.25 | 0.25 | 1 | 0 | 0 |
| C_4 | 0.4 | 0.4 | 0.2 | 1 | 1 | 0 |
| C_5 | 0.333333 | 0.333333 | 0.333333 | 0 | 0 | 0 |
| C_7 | 0.25 | 0.25 | 0.5 | 0 | 0 | 1 |
| C_9 | 0.333333 | 0.333333 | 0.333333 | 0 | 0 | 0 |
| C_12 | 0.333333 | 0.333333 | 0.333333 | 0 | 0 | 0 |
| C_14 | 0.333333 | 0.333333 | 0.333333 | 0 | 0 | 0 |

The clustering module 108 then considers past transaction of the customers to determine the price range in which the one or more customers buy products and based on the distributions the prices column is filled in the above column for all the customers as illustrated in Table 14 below. In the instant examples, few customers in the table may fall in none of the price ranges used for experimenting new strategies.

TABLE 14

| | Cluster_1 | Cluster_2 | Cluster_3 | P1 | P2 | P3 |
|---|---|---|---|---|---|---|
| C_1 | 0.5 | 0.25 | 0.25 | 1 | 0 | 0 |
| C_4 | 0.4 | 0.4 | 0.2 | 1 | 1 | 0 |
| C_5 | 0.333333 | 0.333333 | 0.333333 | 0 | 0 | 0 |
| C_7 | 0.25 | 0.25 | 0.5 | 0 | 0 | 1 |
| C_9 | 0.333333 | 0.333333 | 0.333333 | 1 | 0 | 0 |
| C_12 | 0.333333 | 0.333333 | 0.333333 | 1 | 1 | 0 |
| C_14 | 0.333333 | 0.333333 | 0.333333 | 1 | 0 | 0 |

In an embodiment of the present invention, clustering for customers based on the price range they buy from is performed. Further, only 3 clusters are considered because of the small dataset in the present example. The clustering modules selects more price ranges than 3 for larger datasets. In an embodiment of the present invention, this clustering is performed using one or more Self Organizing maps which define the closeness of a person to different price levels. After the closeness is determined, the clustering module 108 determines preference or affinity of customer towards different price levels. After clustering based on prices the following matrix illustrated in Table 15 is generated.

TABLE 15

| | Cluster_1 | Cluster_2 | Cluster_3 | P1 | P2 | P3 | Cluster |
|---|---|---|---|---|---|---|---|
| C_1 | 0.5 | 0.25 | 0.25 | 1 | 0 | 0 | 2 |
| C_4 | 0.4 | 0.4 | 0.2 | 1 | 1 | 0 | 2 |
| C_5 | 0.333333 | 0.333333 | 0.333333 | 0 | 0 | 0 | 1 |
| C_7 | 0.25 | 0.25 | 0.5 | 0 | 0 | 1 | 3 |
| C_9 | 0.333333 | 0.333333 | 0.333333 | 1 | 0 | 0 | 2 |
| C_12 | 0.333333 | 0.333333 | 0.333333 | 1 | 1 | 0 | 2 |
| C_14 | 0.333333 | 0.333333 | 0.333333 | 1 | 0 | 0 | 2 |

The clustering of customers based on the price ranges they are more probable to choose from further facilitates in distinguishing between customers who have same probabilities associated with different authors and books (same probabilities mainly because of sparse training set).

The quantification of the affinity of a particular customer towards a set of features of a product is complete. Further, the quantification of affinities or probability of customer Ci buying a product Pi with certain feature is:

P(Cᵢ,AᵢGᵢ|Genre,Author,Price,PrintDate,NumberOPages, . . . .)

In the present example, we have customer, author, genre and price. The input for a product detail is in vector with binary elements and the price cluster and genre is used to find the probability of customer buying from a particular genre from the matrix illustrated in Table 4 generated above. For example, for determining probabilities for the customer C_1 of buying a book from genre G2 and author A2 referred as A2_G2 in the price range P2 and the general price cluster is Cluster 2 is represented in vector form as generally as (Cluster 1, Cluster 2, Cluster 3, P1, P2, P3, Price Cluster, Genre). The vector values of (A2_G2, P2, Price Cluster 3) for customer C_1 are (0,1,0,0,1,2,G2).

In an embodiment of the present invention, the first five elements are first multiplied to the values in the matrix illustrated in Table 15 and then with the probability of choosing the genre and then the closeness of customer price range to the price range the product is in. If the difference between the price cluster preferred by the customer is 0, like in the present example then the final probability is multiplied with 1 and if the difference is 3 and price range 2 then the final probability is multiplied by 0.75 or any other number smaller than 1 based on the decision of the product manager which depends on formulation of his strategy. In an embodiment of the present invention, using random decreasing number for increasing difference also provides good results.

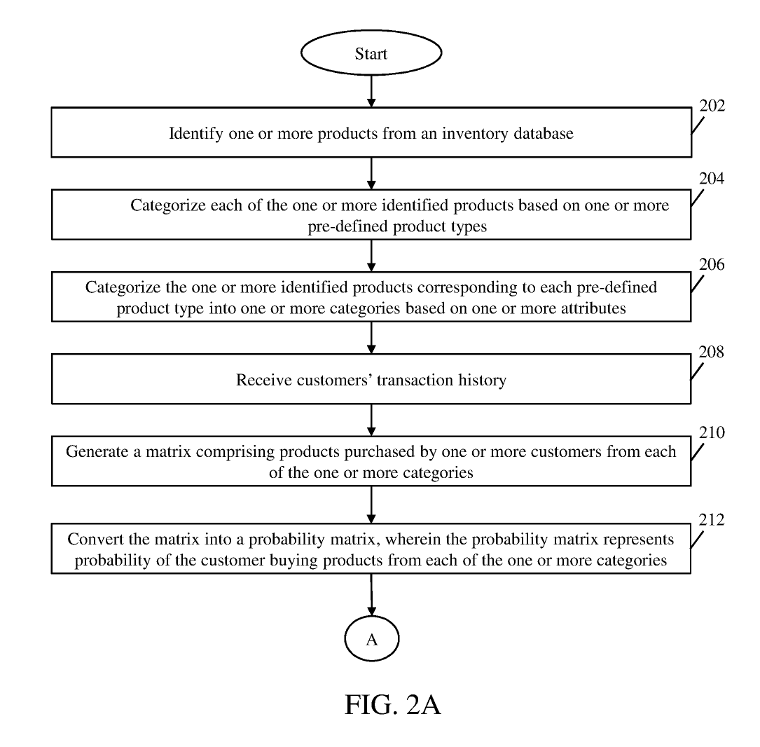

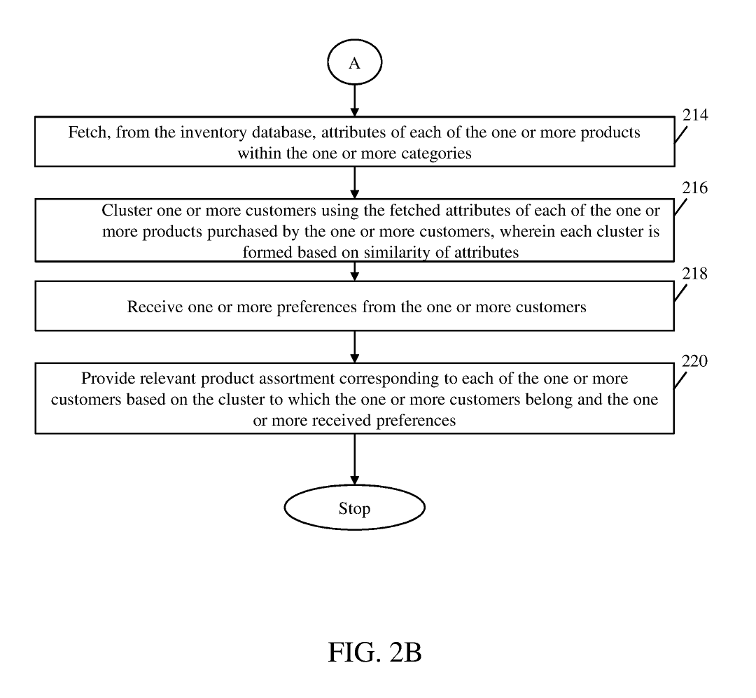

FIGS. 2A and 2B represent a flowchart illustrating a method for efficiently determining relevant products for display in an online marketplace, in accordance with an embodiment of the present invention.

At step 202, one or more products from an inventory database are identified. The inventory database is part of an existing enterprise system. The inventory database comprises information related to browsing history of the one or more customers, products viewed by the one or more customers, products purchased by the one or more customers, transaction history of the one or more customers, products available for sale, sold out products and category and attributes of all the products.

At step 204, each of the one or more identified products are categorized based on one or more pre-defined product types. In an embodiment of the present invention, the one or more pre-defined product types include, but not limited to, books, clothing, jewelry and appliances.

At step 206, the one or more identified products corresponding to each pre-defined product type are further categorized based on one or more attributes. The one or more attributes in case of books include, but not limited to, genre, number of pages, name of the author, number of pages in a book, last print date, price and discount.

At step 208, transaction history of one or more customers is received. The one or more customers access a customer interface provided by the enterprise application to purchase one or more products. The transaction history of the one or more customers is automatically pulled from a customer profiles database to facilitate determination of most relevant products to be displayed to the one or more customers for a current shopping session.

At step 210, a matrix comprising products purchased by the one or more customers from each of the one or more categories is generated. At step 212, the generated matrix is converted into a probability matrix, wherein the probability matrix represents probability of the customer buying products from each of the one or more categories. The matrix will be sparse for some categories due to lack of purchases in those categories by the one or more customers. In an embodiment of the present invention, Laplace smoothing is employed to ensure that categories from which the customer has not purchased any products are assigned a probability value. In another embodiment of the present invention, Good-Turning method is employed to assign probability values to categories from which the customer has not purchased any products. Once probability values are assigned to each category for the one or more customers, collinearity coefficients are computed and coefficients with respect to the most preferable category are added to the probability values of other categories in the matrix. The matrix is then normalized.

At step 214, one or more attributes of each of the one or more products within the one or more categories are fetched from the inventory database. The matrix is then updated to represent number of times each product within the one or more categories was bought by each of the one or more customers.

In an embodiment of the present invention, during operation, each individual product within a category is considered. The products within a category are defined by their attributes. For example, in case of books, the books within a genre (example sci-fi) are segregated based on an attribute such as, but not limited to, name of the author, number of pages in a book, last print date, price and discount. Each class variable (i.e. category) is then converted to corresponding dummy variables (example author denoted by A_i wherein A_i represents i^{th} author). The matrix then shows number of products bought for each dummy variable (A_1 to A_4 represent authors for sci-fi category) by the customer.

At step 216, one or more customers are clustered using the fetched attributes of each of the one or more products purchased by the one or more customers, wherein each cluster is formed based on similarity of attributes. In an embodiment of the present invention, the customers are clustered using a clustering algorithm. In an embodiment of the present invention, k-means clustering is employed based on the attributes with maximum number of levels/class. Once the one or more customers are clustered, the clustering is performed for the attributes. For instance, in the above-mentioned examples of books, similar authors are clustered as one class. The clusters obtained are then converted to new variables in the matrix and the initial components of the matrix are removed. The new variables in the updated matrix are assumed to be independent and probability of the one or more customers buying from the clusters of attributes is computed.

In an embodiment of the present invention, weighted clustering is performed based on price of products. Weighted clustering is performed by scaling the price according to the customer preference. Further, probability is computed for selecting a single row from the above matrix using a Multinomial Logit Model while assuming the distribution to be Gumble.

At step 218, one or more preferences are received from the one or more customers for an instant shopping session. Further, the one or more preferences from the one or more customers for the instant shopping session are received by providing a set of questions to the one or more customers.

At step 220, relevant product assortment corresponding to each of the one or more customers is provided based on the cluster to which the one or more customers belong and the one or more received preferences.

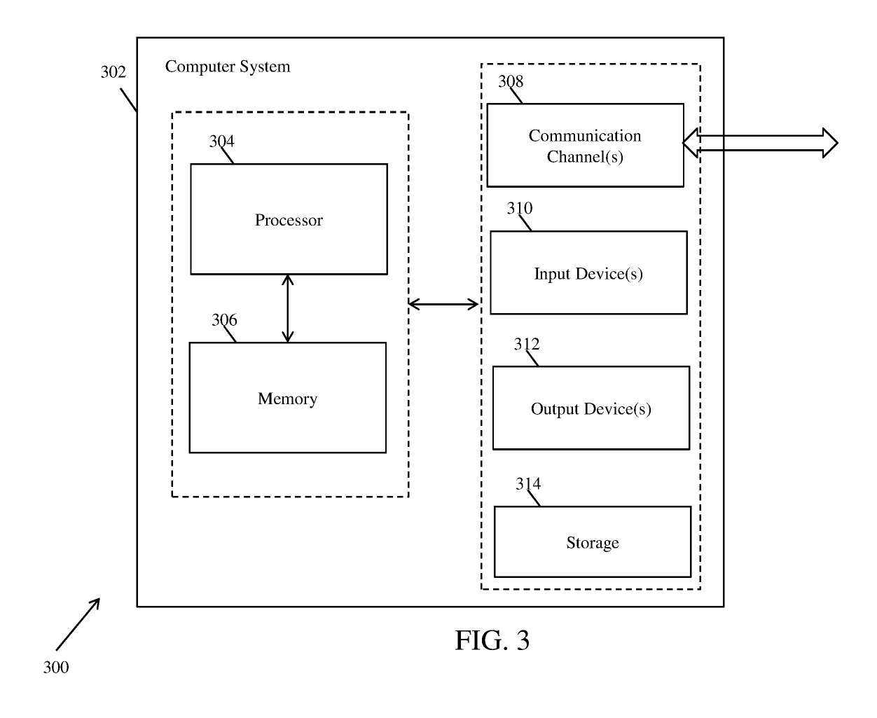

FIG. 3 illustrates an exemplary computer system for efficiently determining relevant products for display in an online marketplace, in accordance with an embodiment of the present invention

The computer system 302 comprises a processor 304 and a memory 306. The processor 304 executes program instructions and may be a real processor. The processor 304 may also be a virtual processor. The computer system 302 is not intended to suggest any limitation as to scope of use or functionality of described embodiments. For example, the computer system 302 may include, but not limited to, a general-purpose computer, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various softwares executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 310 may include, but not limited to, a keyboard, mouse, pen, joystick, trackball, a voice device, a scanning device, or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as an apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A computer-implemented method for determining relevant products for display in an online marketplace, via program instructions stored in a memory and executed by a processor, the computer-implemented method comprising:
identifying one or more products from an inventory database;
categorizing each of the one or more identified products based on one or more pre-defined product types;
categorizing the one or more identified products corresponding to each pre-defined product type into one or more categories based on one or more attributes;
receiving a transaction history of the one or more customers;
generating a matrix comprising products purchased by one or more customers from each of the one or more categories;
converting the generated matrix into a probability matrix, wherein the probability matrix represents probability of the one or more customer buying products from each of the one or more categories;
fetching, from the inventory database, attributes of each of the one or more products within the one or more categories;
clustering the one or more customers using the fetched attributes of each of the one or more products purchased by the one or more customers and the probability matrix;
receiving one or more preferences from the one or more customers for an instant shopping session; and
displaying relevant product assortment corresponding to each of the one or more customers based on the cluster to which the one or more customers belong and the one or more received preferences.

2. The computer implemented method of claim 1, wherein the inventory database is part of an existing enterprise system and comprises information related to browsing history of the one or more customers, products viewed by the one or more customers, products purchased by the one or more customers, transaction history of the one or more customers, products available for sale, sold out products and category and attributes of all the products.

3. The computer implemented method of claim 1, wherein the one or more pre-defined product types comprise books, clothing, jewelry and appliances.

4. The computer implemented method of claim 1, wherein the one or more preferences from the one or more customers for the instant shopping session are received by providing a set of questions to the one or more customers.

5. The computer implemented method of claim 1, wherein the one or more customers are clustered based on similarity of the fetched attributes of each of the one or more products purchased by the one or more customers.

6. A system for determining relevant products for display in an online marketplace, the system comprising:
a stock categorization module configured to:
identify one or more products from an inventory database;
categorize each of the one or more identified products based on one or more pre-defined product types; and
categorize the one or more identified products corresponding to each pre-defined product type into one or more categories based on one or more attributes;
a matrix generator configured to:
receive a transaction history of the one or more customers; and
generate a matrix comprising products purchased by one or more customers from each of the one or more categories;
a probability calculator configured to convert the generated matrix into a probability matrix, wherein the probability matrix represents probability of the one or more customer buying products from each of the one or more categories;
a clustering module configured to:
fetch, from the inventory database, attributes of each of the one or more products within the one or more categories; and
cluster the one or more customers using the fetched attributes of each of the one or more products purchased by the one or more customers and the probability matrix;
a customer questions database configured to receive one or more preferences from the one or more customers for an instant shopping session; and
a category list generator configured to display relevant product assortment corresponding to each of the one or more customers based on the cluster to which the one or more customers belong and the one or more received preferences.

7. The system of claim 6, wherein the inventory database is part of an existing enterprise system and comprises information related to browsing history of the one or more customers, products viewed by the one or more customers, products purchased by the one or more customers, transaction history of the one or more customers, products available for sale, sold out products and category and attributes of all the products.

8. The system of claim 6, wherein the one or more pre-defined product types comprise books, clothing, jewelry and appliances.

9. The system of claim 6, wherein the one or more preferences from the one or more customers for the instant shopping session are received by providing a set of questions to the one or more customers.

10. The system of claim 6, wherein the one or more customers are clustered based on similarity of the fetched attributes of each of the one or more products purchased by the one or more customers.

11. A computer program product for determining relevant products for display in an online marketplace, the computer program product comprising:
a non-transitory computer-readable medium having computer-readable program code stored thereon, the computer-readable program code comprising instructions that when executed by a processor, cause the processor to:
identify one or more products from an inventory database;
categorize each of the one or more identified products based on one or more pre-defined product types;
categorize the one or more identified products corresponding to each pre-defined product type into one or more categories based on one or more attributes;
receive a transaction history of the one or more customers;
generate a matrix comprising products purchased by one or more customers from each of the one or more categories;
convert the generated matrix into a probability matrix, wherein the probability matrix represents probability of the one or more customer buying products from each of the one or more categories;
fetch, from the inventory database, attributes of each of the one or more products within the one or more categories;
cluster the one or more customers using the fetched attributes of each of the one or more products purchased by the one or more customers and the probability matrix;
receive one or more preferences from the one or more customers for an instant shopping session; and
display relevant product assortment corresponding to each of the one or more customers based on the cluster to which the one or more customers belong and the one or more received preferences.

12. The computer program product of claim 11, wherein the inventory database is part of an existing enterprise system and comprises information related to browsing history of the one or more customers, products viewed by the one or more customers, products purchased by the one or more customers, transaction history of the one or more customers, products available for sale, sold out products and category and attributes of all the products.

13. The computer program product of claim 11, wherein the one or more pre-defined product types comprise books, clothing, jewelry and appliances.

14. The computer program product of claim 11, wherein the one or more preferences from the one or more customers for the instant shopping session are received by providing a set of questions to the one or more customers.

15. The computer program product of claim 11, wherein the one or more customers are clustered based on similarity of the fetched attributes of each of the one or more products purchased by the one or more customers.
